(19) United States
(12) Patent Application Publication
(10) Pub. No.: US 2025/0025958 A1
(43) Pub. Date: Jan. 23, 2025

(54) LASER PROCESSING APPARATUS

(71) Applicant: DISCO CORORATION, Tokyo (JP)

(72) Inventors: Yuji HADANO, Tokyo (JP); Keiji NOMARU, Tokyo (JP); Koji TOYAMA, Tokyo (JP)

(21) Appl. No.: 18/775,455

(22) Filed: Jul. 17, 2024

(30) Foreign Application Priority Data
Jul. 18, 2023 (JP) 2023-116882

(51) Int. Cl. B23K 26/062; B23K 26/06; B23K 26/082

(52) U.S. Cl. CPC B23K 26/062; B23K 26/0643; B23K 26/0648; B23K 26/082

(57) ABSTRACT

A laser processing apparatus includes a laser oscillator that generates a laser beam to be condensed and applied to a workpiece held by a holding unit, and a scanning unit that scans the laser beam over the workpiece in an X-direction orthogonal to a Y-direction. The scanning unit includes a scanner that scans the laser beam emitted from the laser oscillator, in the X-direction, a first lens that the laser beam from the scanner enters and that makes the laser beam perpendicular to the workpiece, and a second lens that condenses the laser beam emitted from the first lens, in the Y-direction. A length in the X-direction of each of the first lens and the second lens is set equal to or more than a length in the X-direction of the workpiece held by the holding unit.

### BACKGROUND OF THE INVENTION

### Field of the Invention

The present invention relates to a laser processing apparatus.

### Description of the Related Art

A laser processing apparatus is widely used which performs laser processing on a workpiece by moving a holding unit holding the workpiece in a processing feed direction and an indexing feed direction relative to a laser beam by a moving mechanism while condensing the laser beam on the workpiece and thus irradiating the workpiece with the laser beam (see Japanese Patent Laid-open No. 2013-031871, for example).

### SUMMARY OF THE INVENTION

The moving mechanism of the laser processing apparatus illustrated in Japanese Patent Laid-open No. 2013-031871 utilizes a shaft unit using a ball screw or a linear motor. There is a fear that the position of a condensing point of the laser beam may be displaced from a desired position because of thermal expansion of the periphery of the shaft unit or a condensing lens holder due to friction heat generated with processing feed movement. An optical system for a laser processing position is therefore corrected as appropriate. Thus, a further improvement is desired.

It is accordingly an object of the present invention to provide a laser processing apparatus that can suppress displacement of a processing position.

In accordance with an aspect of the present invention, there is provided a laser processing apparatus including a holding unit configured to hold a workpiece, a laser oscillator configured to generate a laser beam to be condensed and applied to the workpiece held by the holding unit, an indexing feed unit configured to move the holding unit holding the workpiece in a Y-direction relative to a condensing point of the laser beam, and a scanning unit configured to scan the laser beam emitted from the laser oscillator, over the workpiece held by the holding unit, in an X-direction orthogonal to the Y-direction, the scanning unit includes a scanner configured to scan the laser beam emitted from the laser oscillator, in the X-direction, a first lens that the laser beam from the scanner enters and is configured to have, in the X-direction, a curvature that makes the laser beam perpendicular to the workpiece held by the holding unit, and a second lens configured to have, in the Y-direction, a curvature that causes the laser beam emitted from the first lens to be condensed in the Y-direction, and a length in the X-direction of each of the first lens and the second lens is set equal to or more than a length in the X-direction of the workpiece held by the holding unit.

Preferably, the scanner is formed by a polygon scanner having a plurality of mirrors configured to reflect the laser beam emitted from the laser oscillator.

Preferably, the laser processing apparatus further includes a liquid supply unit disposed between the second lens and the holding unit and configured to supply liquid to at least a region irradiated with the laser beam in an upper surface of the workpiece held by the holding unit, and the liquid supply unit includes a transmitting window configured to transmit the laser beam condensed by the second lens, and a liquid supply section having a liquid jetting port formed so as to be adjacent to the transmitting window in the Y-direction.

The present invention produces an effect of being able to suppress displacement of a processing position.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view schematically illustrating an example of a configuration of a laser processing apparatus according to a first embodiment;

FIG. 2 is a perspective view schematically illustrating a wafer to be processed by the laser processing apparatus according to the first embodiment;

FIG. 3 is another perspective view of the laser processing apparatus illustrated in FIG. 1;

FIG. 4 is a perspective view schematically illustrating a configuration of a laser beam irradiating unit of the laser processing apparatus illustrated in FIG. 1;

FIG. 5 is a perspective view schematically illustrating a first lens and the like of the laser beam irradiating unit illustrated in FIG. 4;

FIG. 6 is a perspective view schematically illustrating a second lens and the like of the laser beam irradiating unit illustrated in FIG. 4;

FIG. 7 is a perspective view schematically illustrating an example of a configuration of a laser processing apparatus according to a second embodiment;

FIG. 8 is another perspective view of the laser processing apparatus illustrated in FIG. 7;

FIG. 9 is a side view schematically illustrating, partly in section, a configuration of a liquid supply unit and the like of the laser processing apparatus illustrated in FIG. 7;

FIG. 10 is a plan view of the liquid supply unit illustrated in FIG. 9 as viewed from below; and

FIG. 11 is a side view schematically illustrating, partly in section, a state during processing of the laser processing apparatus illustrated in FIG. 7.

### DETAILED DESCRIPTION OF THE PREFERRED EMBODIMENTS

Embodiments of the present invention will hereinafter be described in detail with reference to the drawings. The present invention is not limited by contents described in the following embodiments. In addition, constituent elements described in the following include constituent elements readily conceivable by those skilled in the art and essentially identical constituent elements. Further, configurations described in the following can be combined with each other as appropriate. In addition, various omissions, replacements, or modifications of configurations can be performed without departing from the spirit of the present invention.

### First Embodiment

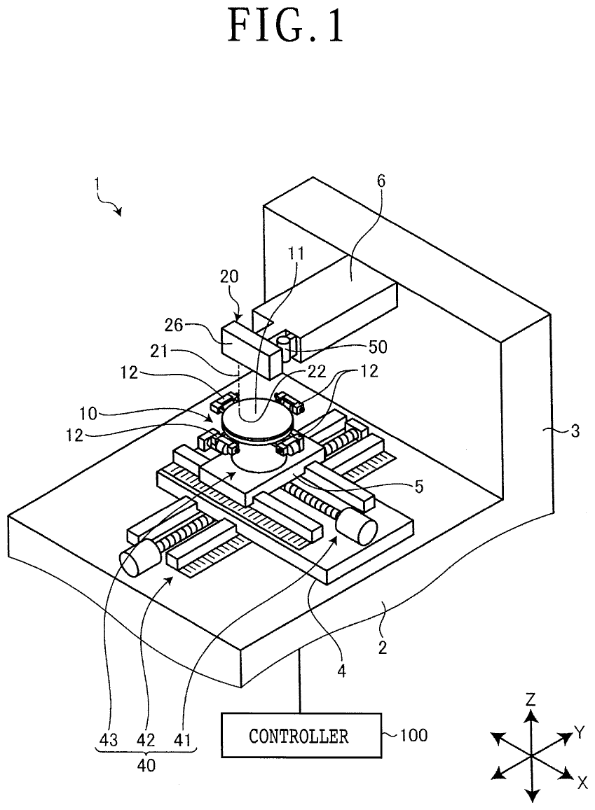

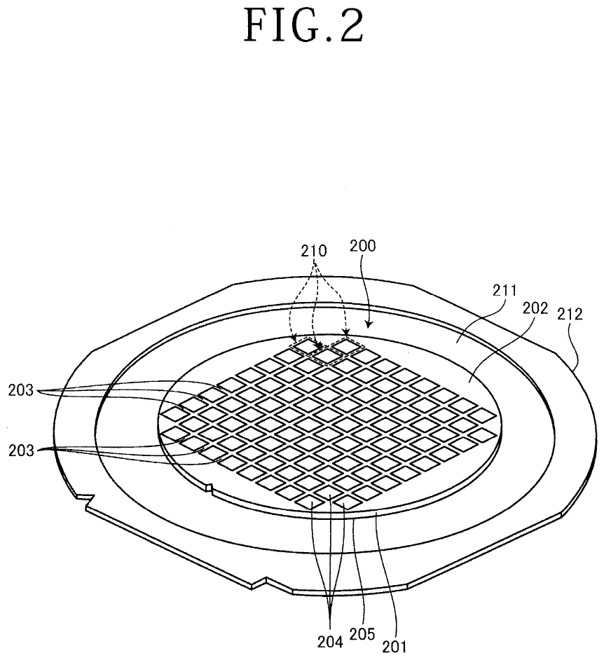

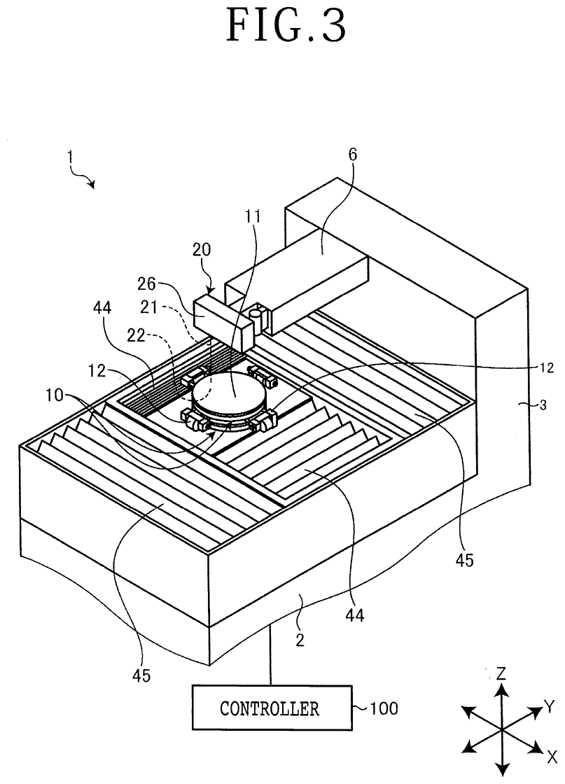

A laser processing apparatus according to a first embodiment of the present invention will be described with reference to the drawings. FIG. 1 is a perspective view schematically illustrating an example of a configuration of the laser processing apparatus according to the first embodiment. FIG. 2 is a perspective view schematically illustrating a wafer to be processed by the laser processing apparatus according to the first embodiment. FIG. 3 is another perspective view of the laser processing apparatus illustrated in FIG. 1.

The laser processing apparatus 1 illustrated in FIG. 1 according to the embodiment is a processing apparatus that processes a workpiece 200 illustrated in FIG. 2. The workpiece 200 to be processed by the laser processing apparatus 1 according to the embodiment is a semiconductor wafer, an optical device wafer, or the like in a disk shape that has silicon (Si), gallium arsenide (GaAs), silicon carbide (SiC), sapphire, or the like as a substrate 201.

As illustrated in FIG. 2, the workpiece 200 has devices 204 respectively formed in regions demarcated by a plurality of intersecting planned dividing lines 203 on a top surface 202. The devices 204 are, for example, integrated circuits such as integrated circuits (ICs) or large scale integrations (LSIs), image sensors such as charge coupled devices (CCDs) or complementary metal oxide semiconductors (CMOSs), optical elements such as light-emitting diodes (LEDs), microelectromechanical systems (MEMS), or semiconductor memories (semiconductor storage apparatuses).

The workpiece 200 is divided into individual chips 210 along the planned dividing lines 203. Incidentally, a chip 210 includes a part of the substrate 201 and a device 204. Incidentally, in the first embodiment, as illustrated in FIG. 2, an adhesive tape 211 having an outer edge portion fitted with an annular frame 212 is affixed to an undersurface 205 on a reverse side of the top surface 202 of the workpiece 200, and the workpiece 200 is divided into individual chips 210 by the laser processing apparatus 1 illustrated in FIG. 1. Incidentally, the adhesive tape 211 may be an adhesive tape including a base material formed by a resin having non-adhesiveness and flexibility and a glue layer laminated to the base material and formed by a resin having adhesiveness and flexibility, the glue layer being affixed to the annular frame 212 and the workpiece 200, or the adhesive tape 211 may be what is called a glueless tape constituted by only a base material formed by a non-adhesive thermoplastic resin, and thermocompression bonded to the annular frame 212 and the workpiece 200.

The laser processing apparatus 1 according to the first embodiment is a processing apparatus that manufactures a plurality of chips 210 by dividing the workpiece 200 having the plurality of planned dividing lines 203 formed thereon along the planned dividing lines 203. The laser processing apparatus 1 according to the first embodiment is a processing apparatus that sets a condensing point 22 of a pulsed laser beam 21 having a wavelength absorbable by the substrate 201 constituting the workpiece 200 on the top surface 202 of the substrate 201, applies the laser beam 21 from the top surface 202 of the workpiece 200 along the planned dividing lines 203, and thereby performs laser processing (referred to also as ablation processing) on the workpiece 200.

As illustrated in FIG. 1, the laser processing apparatus 1 includes a holding unit 10 for holding the workpiece 200, a laser beam irradiating unit 20, a moving unit 40, an imaging unit 50, and a controller 100.

The holding unit 10 holds the workpiece 200 by a holding surface 11 parallel with a horizontal direction. The holding surface 11 is of a disk shape formed of a porous ceramic, quartz, or the like. Suction openings opening in the top surface are formed in the holding surface 11, and the holding surface 11 is connected to a vacuum suction source, not illustrated, via a suction path, not illustrated. The holding unit 10 suction-holds the workpiece 200 mounted on the holding surface 11, by being sucked by the vacuum suction source. A plurality of clamp units 12 that sandwich the annular frame 212 supporting the workpiece 200 within an opening thereof are disposed on the periphery of the holding unit 10.

In addition, the holding unit 10 is rotated by a rotational moving unit 43 of the moving unit 40 about an axis parallel with a Z-direction orthogonal to the holding surface 11 and parallel with a vertical direction. Together with the rotational moving unit 43, the holding unit 10 is moved in an X-direction (corresponding to a processing progress direction) parallel with the horizontal direction by an X-axis moving unit 41 of the moving unit 40, and is moved in a Y-direction parallel with the horizontal direction and orthogonal to the X-direction by a Y-axis moving unit 42. The holding unit 10 is moved by the moving unit 40 between a processing region below the laser beam irradiating unit 20 and a loading and unloading region that is separated from below the laser beam irradiating unit 20 and into and from which the workpiece 200 is loaded or unloaded.

The moving unit 40 moves the holding unit 10 and the condensing point 22 of the laser beam 21 applied by the laser beam irradiating unit 20 relative to each other in the X-direction, in the Y-direction, and about the axis parallel with the Z-direction. The X-direction and the Y-direction are orthogonal to each other, and are directions parallel with the holding surface 11 (that is, the horizontal direction). The Z-direction is a direction orthogonal to both the X-direction and the Y-direction.

The moving unit 40 includes the X-axis moving unit 41 as a processing feed unit that moves the holding unit 10 in the X-direction, the Y-axis moving unit 42 as an indexing feed unit that moves the holding unit 10 in the Y-direction, and the rotational moving unit 43 that rotates the holding unit 10 about the axis parallel with the Z-direction.

The Y-axis moving unit 42 is an indexing feed unit that moves the holding unit 10 holding the workpiece 200, in the Y-direction relative to the condensing point 22 of the laser beam 21 of the laser beam irradiating unit 20. In the first embodiment, the Y-axis moving unit 42 is installed on an apparatus main body 2 of the laser processing apparatus 1. The Y-axis moving unit 42 supports a moving plate 4 supporting the X-axis moving unit 41, movably in the Y-direction.

The X-axis moving unit 41 is a processing feed unit that moves the holding unit 10 in the X-direction relative to the condensing point 22 of the laser beam 21 of the laser beam irradiating unit 20. The X-axis moving unit 41 is installed on the moving plate 4. The X-axis moving unit 41 supports a second moving plate 5 movably in the X-direction, the second moving plate 5 supporting the rotational moving unit 43 that rotates the holding unit 10 about the axis parallel with the Z-direction. The second moving plate 5 supports the rotational moving unit 43 and the holding unit 10. The rotational moving unit 43 supports the holding unit 10.

The X-axis moving unit 41 includes a well-known ball screw that is provided so as to be rotatable about an axis and moves the second moving plate 5 in the X-direction when rotated about the axis, a well-known pulse motor that rotates the ball screw about the axis, and well-known guide rails that support the second moving plate 5 movably in the X-direction. The Y-axis moving unit 42 includes a well-known ball screw that is provided so as to be rotatable about an axis and moves the moving plate 4 in the Y-direction when rotated about the axis, a well-known pulse motor that rotates the ball screw about the axis, and well-known guide rails that support the moving plate 4, movably in the Y-direction. The rotational moving unit 43 includes a motor that rotates the holding unit 10 about the axis and the like.

Incidentally, In the laser processing apparatus 1 in the first embodiment, as illustrated in FIG. 3, the X-axis moving unit 41 is covered by X-axis moving unit protective bellows 44 attached to the apparatus main body 2 and the second moving plate 5, and the Y-axis moving unit 42 is covered by Y-axis moving unit protective bellows 45 attached to the apparatus main body 2.

In addition, the laser processing apparatus 1 includes an X-direction position detecting unit, not illustrated, for detecting the position in the X-direction of the holding unit 10, a Y-direction position detecting unit, not illustrated, for detecting the position in the Y-direction of the holding unit 10, and a Z-direction position detecting unit, not illustrated, for detecting the position in the Z-direction of a condensing lens of the laser beam irradiating unit 20. Each of the position detecting units outputs a detection result to the controller 100. Incidentally, in the first embodiment, the positions in the X-direction and the Y-direction of the holding unit 10 of the laser processing apparatus 1 and the position in the Z-direction of the condensing lens of the laser beam irradiating unit 20 are defined by distances in the X-direction, the Y-direction, and the Z-direction from a predetermined reference position, not illustrated, or the like.

The laser beam irradiating unit 20 is laser beam irradiating means for condensing the pulsed laser beam 21 on the workpiece 200 held on the holding surface 11 of the holding unit 10 and irradiating the workpiece 200 with the pulsed laser beam 21. In the first embodiment, as illustrated in FIG. 1 and FIG. 3, a part of the laser beam irradiating unit 20 is disposed at a distal end of a supporting column 6 supported by an erected wall 3 erected from the apparatus main body 2. Incidentally, a configuration of the laser beam irradiating unit 20 will be described later.

The imaging unit 50 images the workpiece 200 held by the holding unit 10. The imaging unit 50 includes an imaging element such as a charge coupled device (CCD) imaging element or a CMOS imaging element that images an object that an objective lens faces in the Z-direction. In the first embodiment, as illustrated in FIG. 1, the imaging unit 50 is disposed at the distal end of the supporting column 6.

The imaging unit 50 obtains an image captured by the imaging element, and outputs the obtained image to the controller 100. In addition, the imaging unit 50 images the workpiece 200 held on the holding surface 11 of the holding unit 10, and obtains an image for carrying out alignment for aligning the workpiece 200 and the laser beam irradiating unit 20 with each other.

The controller 100 makes the laser processing apparatus 1 perform a processing operation on the workpiece 200 by controlling each of the above-described constituent elements of the laser processing apparatus 1. Incidentally, the controller 100 is a computer including an arithmetic processing apparatus having a microprocessor such as a central processing unit (CPU), a storage apparatus having a memory such as a read only memory (ROM) or a random access memory (RAM), and an input-output interface apparatus. The arithmetic processing apparatus of the controller 100 implements functions of the controller 100 by performing arithmetic processing according to a computer program stored in the storage apparatus, and outputting control signals for controlling the laser processing apparatus 1 to the above-described constituent elements of the laser processing apparatus 1 via the input-output interface apparatus.

In addition, the laser processing apparatus 1 includes a display unit as display means constituted by a liquid crystal display apparatus or the like that displays a state of the processing operation, an image, or the like, and an input unit as input means used when an operator inputs processing conditions or the like. The display unit and the input unit are connected to the controller. In the first embodiment, the input unit is constituted by a touch panel provided to the display unit.

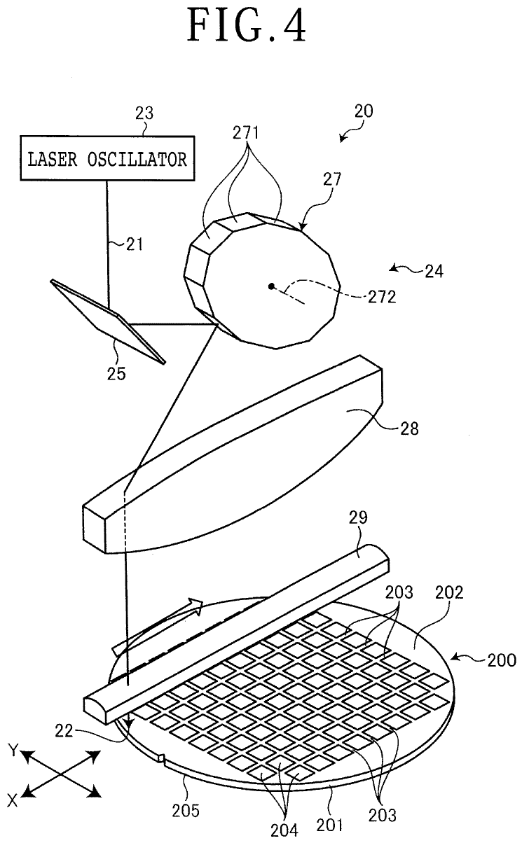

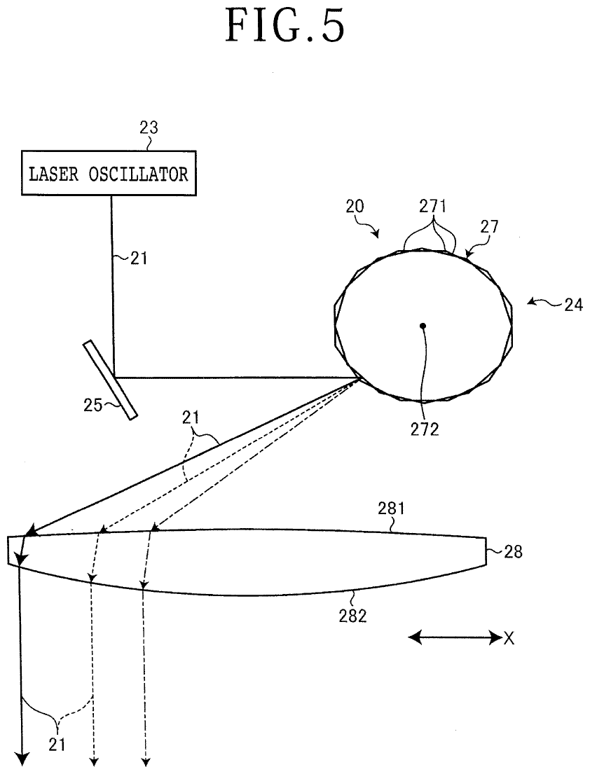

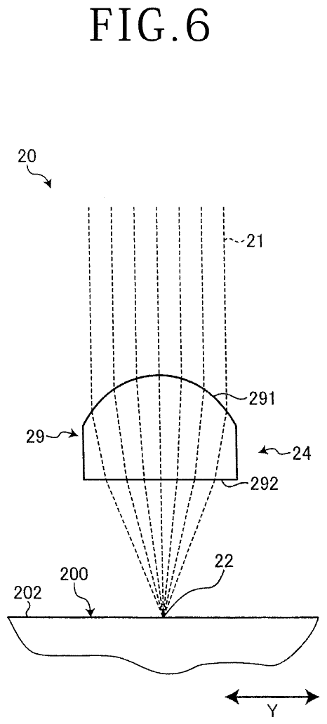

A configuration of the laser beam irradiating unit 20 will next be described. FIG. 4 is a perspective view schematically illustrating a configuration of the laser beam irradiating unit of the laser processing apparatus illustrated in FIG. 1. FIG. 5 is a perspective view schematically illustrating a first lens and the like of the laser beam irradiating unit illustrated in FIG. 4. FIG. 6 is a perspective view schematically illustrating a second lens and the like of the laser beam irradiating unit illustrated in FIG. 4.

As illustrated in FIG. 4, the laser beam irradiating unit 20 includes a laser oscillator 23 as a light source and a scanning unit 24. The laser oscillator 23 is to generate the laser beam 21 to be applied so as to be condensed on the workpiece 200 held by the holding unit 10. The laser oscillator 23 generates and emits the laser beam 21 having a predetermined wavelength for processing the workpiece 200. In addition, in the first embodiment, as illustrated in FIG. 4, the laser beam irradiating unit 20 includes a mirror 25 that reflects the laser beam 21 emitted by the laser oscillator 23, toward a scanner 27 of the scanning unit 24.

The scanning unit 24 scans the laser beam 21 emitted from the laser oscillator 23 over the workpiece 200 held by the holding unit 10 in the X-direction orthogonal to the Y-direction to condense and apply the laser beam 21 over an entire length of a planned dividing line 203 of the workpiece 200. As illustrated in FIG. 4, the scanning unit 24 includes a casing 26 (illustrated in FIG. 1 and FIG. 3), the scanner 27, a first lens 28, and a second lens 29.

The casing 26 is disposed at the distal end of the supporting column 6. The casing 26 is a case that houses the scanner 27, the first lens 28, and the second lens 29. The casing 26 has an opening formed in a lower portion thereof, the opening exposing the second lens 29 downward.

The scanner 27 scans the laser beam 21 emitted from the laser oscillator 23 in the X-direction. In the first embodiment, the scanner 27 is a polygon scanner having a plurality of mirrors 271 that reflect the laser beam 21 emitted from the laser oscillator 23. The scanner 27 is supported so as to be rotatable about a rotational axis 272 parallel with the Y-direction, and is provided with a plurality of flat mirrors 271 in the circumferential direction of the rotational axis 272. The scanner 27 scans the laser beam 21 emitted from the laser oscillator 23, in the X-direction, by rotating about the rotational axis 272 and thereby changing the positions of the mirrors 271 reflecting the laser beam 21 and the orientations of the mirrors 271 as illustrated in FIG. 5.

The laser beam 21 from the scanner 27 enters the first lens 28. The first lens 28 has, in the X-direction, a curvature that makes the laser beam 21 perpendicular to the workpiece 200 held by the holding unit 10. The first lens 28 is a cylindrical lens formed of a light guiding material and having a longitudinal direction parallel with the X-direction. The length in the X-direction of the first lens 28 is set equal to or more than the length (outside diameter in the first embodiment) in the X-direction of the workpiece 200 held by the holding unit 10. The width in the Y-direction of the first lens 28 is set less than the length (outside diameter in the first embodiment) in the Y-direction of the workpiece 200 held by the holding unit 10.

The laser beam 21 from the scanner 27 is made to enter the first lens 28 from an incident surface 281 of the first lens 28. As illustrated in FIG. 5, the laser beam 21 is emitted from an emission surface 282 of the first lens 28 that is curved with respect to the X-direction as viewed from the front with the X-direction as a left-right direction. The first lens 28 consequently makes an optical path of the emitted laser beam 21 parallel with the Z-direction. The first lens 28 thereby makes the laser beam 21 perpendicular to the workpiece 200 held by the holding unit 10. Thus, the first lens 28 has a curvature in the X-direction such that the emission surface 282 makes the laser beam 21 perpendicular to the workpiece 200 held by the holding unit 10.

The second lens 29 has, in the Y-direction, a curvature that causes the laser beam 21 emitted from the first lens 28 to be condensed in the Y-direction. The second lens 29 is a cylindrical lens formed of a light guiding material and having a longitudinal direction parallel with the X-direction. The length in the X-direction of the second lens 29 is set equal to or more than the length (outside diameter in the first embodiment) in the X-direction of the workpiece 200 held by the holding unit 10. The width in the Y-direction of the second lens 29 is set less than the length (outside diameter in the first embodiment) in the Y-direction of the workpiece 200 held by the holding unit 10.

As illustrated in FIG. 6, the laser beam 21 from the first lens 28 enters the second lens 29 from a surface 291 curved with respect to the Y-direction as viewed from the front with the Y-direction as a left-right direction. The second lens 29 emits the laser beam 21 from a flat emission plane 292 parallel with the X-direction and the Y-direction. The second lens 29 thereby irradiates the workpiece 200 held by the holding unit 10 with the emitted laser beam 21 while condensing the laser beam 21 in the Y-direction without condensing the laser beam 21 in the X-direction. Therefore, the condensing point 22 of the laser beam 21 condensed by the second lens 29, that is, the scanning unit 24 is formed in an elliptic shape whose major axis is parallel with the X-direction.

Thus, the second lens 29 has, in the Y-direction, a curvature that causes the laser beam 21 to be condensed in the Y-direction. Incidentally, in the first embodiment, the second lens 29 is located below the first lens 28 such that the surface 291 that is curved with respect to the Y-direction and on which the laser beam is made incident is located on an upper side and the flat emission plane 292 is located on a lower side. The curved emission surface 282 of the first lens 28 of the scanning unit 24 and the curved surface 291, on which the laser beam is made incident, of the second lens 29 thus face each other. Incidentally, in the present invention, the orientations of the lenses 28 and 29 are not limited to the orientations described in the first embodiment, and may be opposite to those of the first embodiment.

Processing operation of the laser processing apparatus 1 according to the first embodiment will next be described. In the laser processing apparatus 1 in the first embodiment, the controller 100 receives and registers processing conditions or the like input by the operator, and the workpiece 200 is mounted on the holding surface 11 of the holding unit 10 positioned in the loading and unloading region. In the first embodiment, when the controller 100 receives an instruction to start the processing operation from the operator, the laser processing apparatus 1 suction-holds the workpiece 200 on the holding surface 11 of the holding unit 10 via the adhesive tape 211, and holds the annular frame 212 by the clamp units 12.

In the laser processing apparatus 1 in the first embodiment, the controller 100 controls the moving unit 40 to move the holding unit 10 to the processing region, images the workpiece 200 held by the holding unit 10 by the imaging unit 50, and carries out alignment. In the first embodiment, the laser processing apparatus 1 sets the condensing point 22 of the laser beam 21 on the top surface 202 of the substrate 201 on the basis of processing conditions, positions the laser beam irradiating unit 20 above one planned dividing line 203 of the workpiece 200 held by the holding unit 10 by the moving unit 40, reflects the laser beam 21 emitted by the laser oscillator 23 by the mirrors 271 of the scanner 27 about the rotational axis 272, makes the optical path of the laser beam 21 parallel with the Z-direction by the first lens 28, condenses the laser beam 21 in the Y-direction by the second lens 29, and scans the laser beam 21 on the planned dividing line 203. In the first embodiment, the laser processing apparatus 1 scans the condensed laser beam 21 on the planned dividing line 203 without moving the holding unit 10 in the X-axis direction by the X-axis moving unit 41, thus applies the pulsed laser beam 21 from the top surface 202 side of the substrate 201 over an entire length of the planned dividing line 203 of the workpiece 200, and thereby performs ablation processing on the substrate 201 of the workpiece 200 along the planned dividing line 203.

In the first embodiment, when the laser processing apparatus 1 completes the irradiation of the one planned dividing line 203 with the laser beam 21, the controller 100 stops the emission of the laser beam 21 from the laser oscillator 23, controls the Y-axis moving unit 42 to position the laser beam irradiating unit 20 above another planned dividing line 203 of the workpiece 200 held by the holding unit 10, and applies the laser beam 21 over an entire length of the planned dividing line 203 by, for example, emitting the laser beam 21 from the laser oscillator 23 and performing scanning by the scanner 27 without moving the holding unit 10 in the X-axis direction by the X-axis moving unit 41. Thus, in the first embodiment, the laser processing apparatus 1 applies the laser beam 21 over entire lengths of all of the planned dividing lines 203 without moving the holding unit 10 in the X-axis direction by the X-axis moving unit 41, and consequently divides the workpiece 200 into individual chips 210. Incidentally, when the laser processing apparatus 1 irradiates each of the planned dividing lines 203 with the laser beam 21, the controller 100 adjusts an overlap ratio of the laser beam 21 applied to the workpiece 200 as appropriate, by adjusting the rotational speed of the scanner 27 and the repetition frequency of the pulsed laser beam 21 generated by the laser oscillator 23.

In the first embodiment, after the laser processing apparatus 1 irradiates all of the planned dividing lines 203 with the laser beam 21, the laser processing apparatus 1 stops the irradiation with the laser beam 21, and the controller 100 controls the moving unit 40 to move the holding unit 10 to the loading and unloading region, stops the suction-holding of the workpiece 200 by the holding unit 10, and releases the sandwiching of the annular frame 212 by the clamp units 12.

As described above, the laser processing apparatus 1 according to the described first embodiment includes the scanning unit 24 that scans the laser beam generated by the laser oscillator 23, over the workpiece held by the holding unit 10, in the X-direction as a processing feed direction. In addition, in the laser processing apparatus 1 according to the first embodiment, the lengths in the X-direction of the first lens 28 and the second lens 29 of the scanning unit 24 are set equal to or more than that of the workpiece 200.

Therefore, the laser processing apparatus 1 according to the first embodiment can irradiate the workpiece 200 with the laser beam 21 over the entire length of each of the planned dividing lines 203 without moving the holding unit 10 by the X-axis moving unit 41 at a time of processing feed that generally involves a high movement speed. As a result, the laser processing apparatus 1 according to the first embodiment produces an effect of being able to suppress a thermal expansion during the processing, and consequently suppress displacement of a processing position as the position of the condensing point 22 of the laser beam 21.

In addition, the laser processing apparatus 1 according to the first embodiment can reduce aberration because the emission surface 282, which has a higher curvature, of the first lens 28 of the scanning unit 24 and the curved surface 291, on which the laser beam is made incident, of the second lens 29 face each other.

In addition, in the laser processing apparatus 1 according to the first embodiment, the condensing point 22 of the laser beam 21 is formed in an elliptic shape whose major axis is parallel with the X-direction. Therefore, a taper of side surfaces of a laser-processed groove formed in the processing progress direction as the X-direction is gentler than that in a case of a laser beam 21 having a circular condensing point 22. A scattering direction of debris is consequently distant from a processing point (point at which the workpiece 200 is irradiated with the laser beam 21), so that the laser-processed groove is prevented from being refilled with the debris.

### Second Embodiment

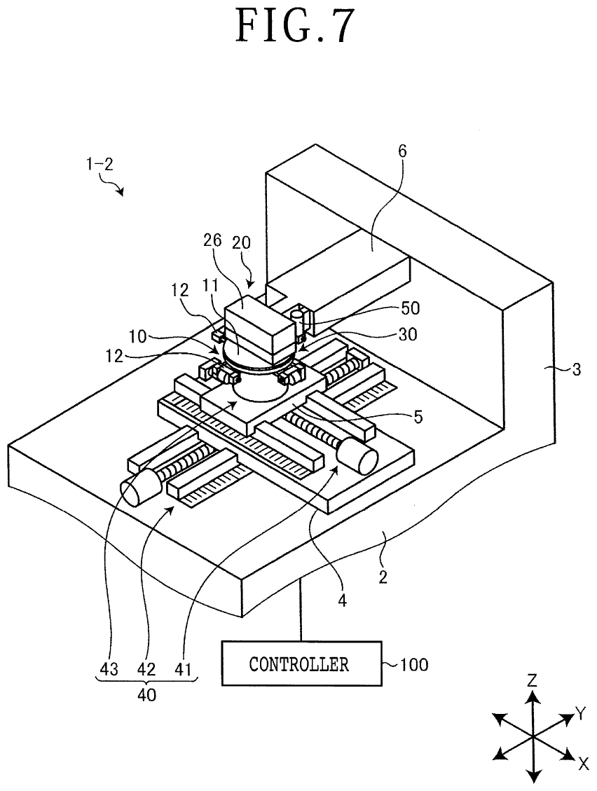

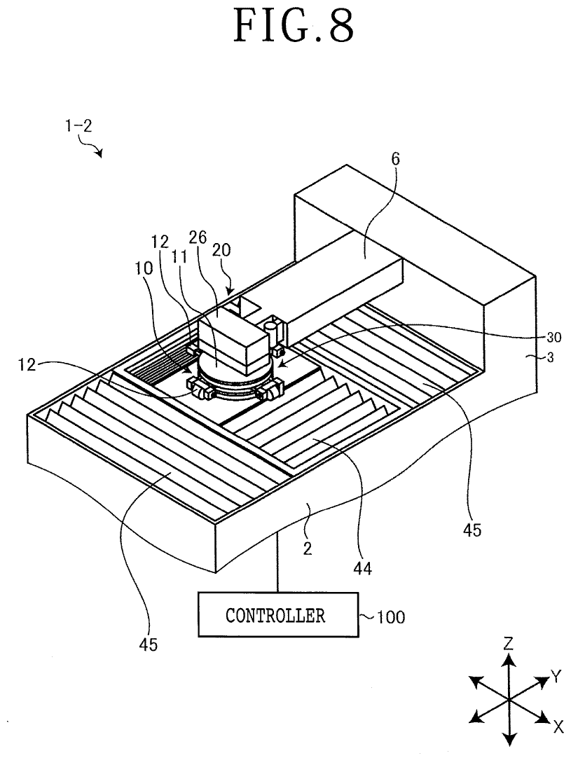

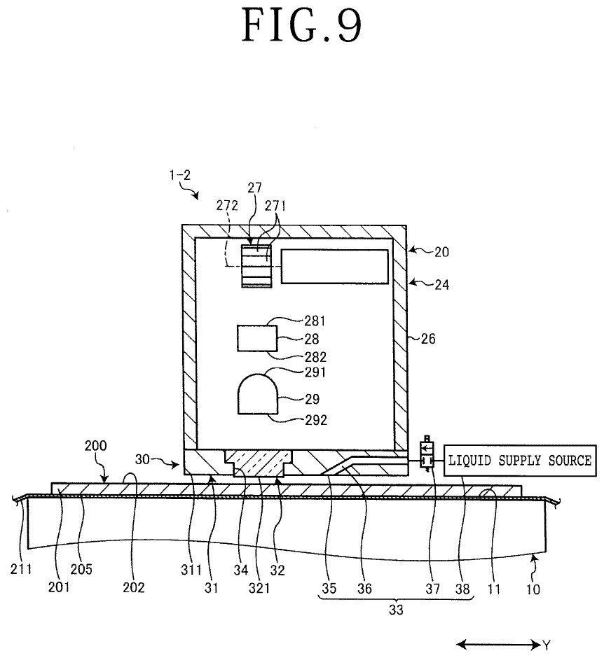

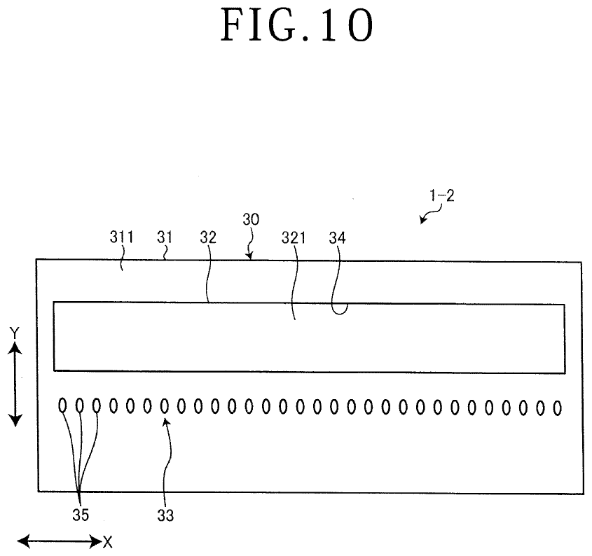

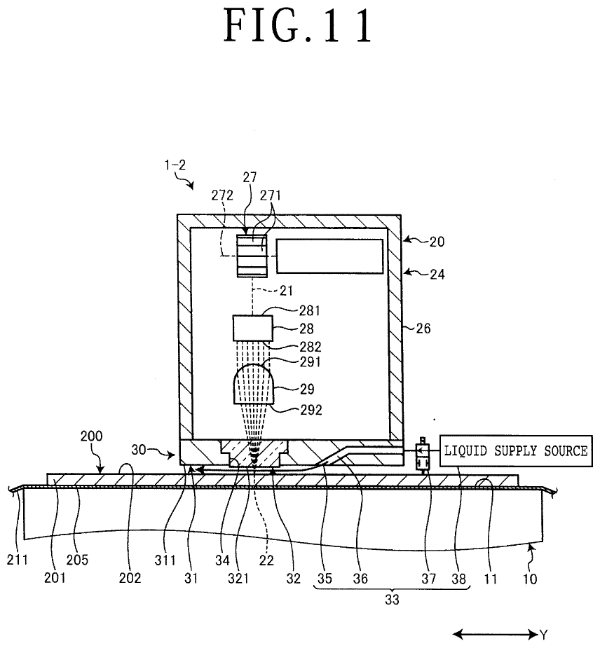

A laser processing apparatus 1 according to a second embodiment will be described with reference to the drawings. FIG. 7 is a perspective view schematically illustrating an example of a configuration of the laser processing apparatus according to the second embodiment. FIG. 8 is another perspective view of the laser processing apparatus illustrated in FIG. 7. FIG. 9 is a side view schematically illustrating, partly in section, a configuration of a liquid supply unit and the like of the laser processing apparatus illustrated in FIG. 7. FIG. 10 is a plan view of the liquid supply unit illustrated in FIG. 9 as viewed from below. FIG. 11 is a side view schematically illustrating, partly in section, a state during processing of the laser processing apparatus illustrated in FIG. 7. Incidentally, in FIG. 7, FIG. 8, FIG. 9, FIG. 10, and FIG. 11, the same parts as in the first embodiment are identified by the same reference signs, and description thereof will be omitted.

A laser processing apparatus 1-2 according to the second embodiment is the same as in the first embodiment except that the laser processing apparatus 1-2 includes a liquid supply unit 30, as illustrated in FIG. 7, FIG. 8, FIG. 9, and FIG. 10. The liquid supply unit 30 is disposed between the second lens 29 and the holding unit 10. The liquid supply unit 30 supplies liquid (for example, pure water) to at least a region irradiated with the laser beam 21 in the top surface 202 as the upper surface of the workpiece 200 held by the holding unit 10.

The liquid supply unit 30 includes a unit main body 31 formed in a shape of a thick flat plate and attached to a lower end of the casing 26 of the scanning unit 24 of the laser beam irradiating unit 20, a transmitting window 32 provided in a position facing the second lens 29 in the Z-direction, and a liquid supply section 33. In the unit main body 31, as illustrated in FIG. 9, an opening 34 that passes the laser beam 21 condensed by the second lens 29 penetrates at a position facing the second lens 29 in the Z-direction.

The transmitting window 32 is formed of a light guiding material. The transmitting window 32 is fitted into the opening 34 to transmit the laser beam 21 condensed by the second lens 29. Incidentally, a lower surface 311 of the unit main body 31 and a lower surface 321 of the transmitting window 32 are formed so as to be flat along the horizontal direction, and the lower surface 321 of the transmitting window 32 is disposed approximately 1 mm or less (for example, a few hundred micrometers) below the lower surface 311 of the unit main body 31. In addition, the lower surface 321 of the transmitting window 32 is disposed 0.5 mm or more and 1.0 mm or less above the top surface 202 of the workpiece 200 held by the holding unit 10.

The liquid supply section 33 includes a liquid jetting port 35, a flow passage 36, an opening and closing valve 37, and a liquid supply source 38. The liquid jetting port 35 opens in the lower surface 311 of the unit main body 31, and is connected to the liquid supply source 38 via the flow passage 36 provided in the unit main body 31 and the opening and closing valve 37. The liquid jetting port 35 is arranged next to the transmitting window 32 in the Y-direction, that is, is formed so as to be adjacent to the transmitting window 32 in the Y-direction. In addition, in the second embodiment, as illustrated in FIG. 10, a plurality of the liquid jetting ports 35 are arranged in the X-direction. The flow passage 36 is inclined in a direction of gradually approaching the transmitting window 32 toward the liquid jetting port 35 with respect to the Z-direction and the Y-direction.

When the laser processing apparatus 1-2 according to the second embodiment irradiates a planned dividing line 203 with the laser beam 21, the laser processing apparatus 1-2 opens the opening and closing valve 37, and supplies the liquid from the liquid supply source 38, from the liquid jetting port 35 to between the liquid supply unit 30 and the region irradiated with the laser beam 21 in the top surface 202 of the workpiece 200, as illustrated in FIG. 11. Then, because the flow passage 36 is inclined as described above and a predetermined flow rate is jetted from the liquid jetting port 35, a flow of the liquid is formed in the Y-direction as indicated by the arrow in FIG. 11, and the liquid is filled between the liquid supply unit 30 and the region irradiated with the laser beam 21 in the top surface 202 of the workpiece 200.

The laser processing apparatus 1-2 according to the second embodiment includes the scanning unit 24 that scans the laser beam emitted from the laser oscillator 23, over the workpiece held by the holding unit 10, in the X-direction as the processing feed direction. The lengths in the X-direction of the first lens 28 and the second lens 29 are set equal to or more than that of the workpiece 200. As a result, the laser processing apparatus 1-2 according to the second embodiment can irradiate the workpiece 200 with the laser beam 21 over the entire length of each of the planned dividing lines 203 without moving the holding unit 10 by the X-axis moving unit 41, and consequently produces an effect of being able to suppress displacement of the processing position as the position of the condensing point 22 of the laser beam 21.

In addition, the laser processing apparatus 1-2 according to the second embodiment irradiates the workpiece 200 with the laser beam 21 in a state in which the liquid is filled between the top surface 202 of the workpiece 200 and the lower surface 321 of the transmitting window 32. The laser processing apparatus 1-2 can therefore reduce damage to the workpiece 200 due to heat generated by the processing.

In addition, the laser processing apparatus 1-2 according to the second embodiment performs the ablation processing while supplying the liquid to the region irradiated with the laser beam 21 on the workpiece 200. The laser processing apparatus 1-2 can therefore efficiently discharge the debris produced by the ablation processing from the workpiece 200.

In addition, in the laser processing apparatus 1-2 according to the second embodiment, when the liquid is irradiated with the laser beam 21, air bubbles are formed in the liquid. When the formed air bubbles are irradiated with the laser beam 21, the air bubbles disperse the laser beam 21 applied thereto, and condense the laser beam 21 on an unintended region. A processing trace is consequently formed.

However, the laser processing apparatus 1-2 according to the second embodiment discharges the air bubbles by jetting the liquid from the liquid jetting port 35, that is, from the vicinity in the Y-direction of the transmitting window 32 toward the transmitting window 32. The laser processing apparatus 1-2 can thereby remove the air bubbles from the region irradiated with the laser beam 21 and vicinities thereof.

Further, in the laser processing apparatus 1-2 according to the second embodiment, the lower surface 321 of the transmitting window 32 slightly protrudes from the lower surface 311 of the liquid supply unit 30. The position of the lower surface 311 of the liquid supply unit 30 on the outside of the transmitting window 32 is consequently higher than the lower surface 321 of the transmitting window 32, so that steps are formed. Thus, even if air bubbles adhere to the lower surface 321 of the transmitting window 32, the adhered air bubbles move to the lower surface 311 side of the liquid supply unit 30. The laser processing apparatus 1-2 according to the second embodiment can therefore reduce a fear of the air bubbles being irradiated with the laser beam 21.

In addition, in the laser processing apparatus 1-2 according to the second embodiment, the condensing point 22 of the laser beam 21 is formed in an elliptic shape whose major axis is parallel with the X-direction, and the workpiece 200 is irradiated with the laser beam 21 in a state in which the liquid is filled between the top surface 202 of the workpiece 200 and the lower surface 321 of the transmitting window 32. Therefore, in a case of forming laser-processed grooves having a same groove width, as compared with a case of applying a laser beam 21 having a circular condensing point 22, the area of the condensing point 22 is increased, and thus energy density is decreased. Consequently, even when scattered light is produced by irradiating the air bubbles with the laser beam 21, damage from the scattered light does not occur easily (that is, the workpiece 200 is not easily processed).

It is to be noted that the present invention is not limited to the foregoing embodiments or the like. That is, the present invention can be variously modified and carried out without departing from the gist of the present invention. For example, in the present invention, the laser oscillator 23 may emit the laser beam 21 having a wavelength transmissible through the substrate 201 of the workpiece 200, and the laser processing apparatus 1 or 1-2 may form a modified layer within the substrate 201 of the workpiece 200 along the planned dividing lines 203. Incidentally, the modified layer refers to a region in which density, a refractive index, mechanical strength, or another physical property is different from that of surroundings, and can be illustrated by a melted region, a crack region, a dielectric breakdown region, a refractive index changed region, a region in which these regions are mixed, and the like. The mechanical strength of the modified layer is lower than that of other parts of the substrate 201.

In addition, in the laser processing apparatus 1 according to the present invention, the first lens 28 and the second lens 29 are not limited to cylindrical lenses, and may be toroidal lenses.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser processing apparatus comprising:
a holding unit configured to hold a workpiece;
a laser oscillator configured to generate a laser beam to be condensed and applied to the workpiece held by the holding unit;
an indexing feed unit configured to move the holding unit holding the workpiece in a Y-direction relative to a condensing point of the laser beam; and
a scanning unit configured to scan the laser beam emitted from the laser oscillator, over the workpiece held by the holding unit, in an X-direction orthogonal to the Y-direction,
the scanning unit including
a scanner configured to scan the laser beam emitted from the laser oscillator, in the X-direction,
a first lens that the laser beam from the scanner enters and is configured to have, in the X-direction, a curvature that makes the laser beam perpendicular to the workpiece held by the holding unit, and
a second lens configured to have, in the Y-direction, a curvature that causes the laser beam emitted from the first lens to be condensed in the Y-direction, and
a length in the X-direction of each of the first lens and the second lens being set equal to or more than a length in the X-direction of the workpiece held by the holding unit.

2. The laser processing apparatus according to claim 1, wherein
the scanner is formed by a polygon scanner having a plurality of mirrors configured to reflect the laser beam emitted from the laser oscillator.

3. The laser processing apparatus according to claim 1, further comprising:
a liquid supply unit disposed between the second lens and the holding unit and configured to supply liquid to at least a region irradiated with the laser beam in an upper surface of the workpiece held by the holding unit, wherein
the liquid supply unit includes
a transmitting window configured to transmit the laser beam condensed by the second lens, and
a liquid supply section having a liquid jetting port formed so as to be adjacent to the transmitting window in the Y-direction.
